(19) United States
(12) Patent Application Publication
(10) Pub. No.: US 2017/0355109 A1
(43) Pub. Date: Dec. 14, 2017

(54) METHODS OF CREATING RAISED COLOR GRAPHICS AND ARTICLES INCORPORATING SAME

(71) Applicant: Identify Group Holdings Corporation, Nashville, TN (US)

(72) Inventor: William M. Stecker, Hillsborough, NC (US)

(21) Appl. No.: 15/617,734

(22) Filed: Jun. 8, 2017

Related U.S. Application Data
(60) Provisional application No. 62/347,873, filed on Jun. 9, 2016.

(51) Int. Cl. B29C 43/02; B29C 43/40; B29K 101/12; B29L 31/00

(52) U.S. Cl. CPC B29C 43/02; B29C 43/40; B29K 2101/12; B29L 2031/722

(57) ABSTRACT

A method of making a decorative article, such as, a sign or plaque. with raised elements/graphics, includes cutting at least one character from a multi-layered sheet, positioning the at least one character on a mold surface, placing a substrate in contacting relationship with the at least one character, wherein the substrate comprises clear or colored thermoplastic material, and applying a compressive force to the substrate and mold such that the at least one character fuses to the substrate. The multi-layered sheet includes a clear first thermoplastic layer, a second thermoplastic layer, and a printed color layer sandwiched between the first and second thermoplastic layers. The at least one character may be an alpha-numeric character an image, or a portion of an image.

### RELATED APPLICATION

This application claims the benefit of and priority to U.S. Provisional Patent Application No. 62/347873 filed Jun. 9, 2016 the disclosure of which is incorporated herein by reference as if set forth in its entirety.

### FIELD OF THE INVENTION

The present invention relates generally to decorative articles and, more particularly, to methods of making decorative articles.

### BACKGROUND OF THE INVENTION

The American with Disabilities Act, the elements of which are becoming international standards in particular and the decorative graphics industry in general, has created a demand for articles manufactured with graphics raised from a substrate with the raised graphics having a color different from and in contrast with the color or colors of the substrate. There are several methods conventionally used to create such articles.

One method involves stock removal followed by colorizing the background and/or raised portion of an article. Stock removal may be done mechanically by using a CNC router or laser—which removes the area around the desired graphics. Alternatively, material may be removed by a process called photo cured photopolymer. This process utilizes a substrate coated with a layer of photo reactive polymers. A light clocking mask is prepared which blocks high intensity UV light where the layer is to be removed. The blocked portion is the part of the polymer layer which is to be removed. The raised text is created where the blacking film allows for UV light to pass through and cure the polymer layer. The areas under the pass through areas are “fixed or cured.” After curing, the article is washed with a solvent which removes the uncured parts of the assembly. The article is then completed with one of a number of processes to colorize the substrate and subsequently the raised portion(s).

The raised portion(s) are then colorized to create contrast with the colored substrate, Two processes conventionally used to color the raised portions include, tipping and foil stamping. Tipping uses a silkscreen process to apply colored ink to the raised areas. For articles which require multiple colors the screen ink is applied selectively to different areas with raised area of different colors done with consecutive passes through the tipping process. Unfortunately, this may be a tedious and labor intensive process. A foil stamping method uses a photopolymer and a colored plastic membrane thermally affixed to selected raised area with a hot platen process.

Another conventional method of creating raised portions is by abrasive oblation which uses sand blasting and masks to oblate away a substrate leaving the desired raised areas. Subsequent processing is the same as for photopolymers. Direct machining of surfaces likewise may require the same colorizing steps described above.

Another conventional method for creating raised portions is by direct deposit with a digital flatbed printer or 3D printer, 3D printing typically deposits a single color reactive polymer layer on a substrate which still requires the colorizing previously outlined. Direct printing with a flatbed printer which builds up the raised areas with thin layers of UV cured ink, allows for an article to be created with no need for additional colorizing steps. The process has drawbacks of being slow and requiring an expensive printer. For example, to build up .032″ of polymer may require 15-30 passes by the printer heads, The ink build up is also typically brittle and vulnerable to impact damage,

Another conventional method for creating raised portions is called applied graphics and involves cutting out the desired color and shapes of graphics and gluing these elements to a substrate. This method may be accomplished with several alternatives for the composition of the raised elements. All of the raised elements have an adhesive layer on the reverse side of the feed stock, This may be done by cutting out solid color material, for example, with a laser. The glue is typically a pressure set adhesive. Elements without glue may be chemically welded to the substrate, Unfortunately, this is a tedious and labor intensive process. Moreover, pressure-sensitive adhesives may be vulnerable to failure because of the elastic bond in addition, text graphics, especially done with narrow letter stroke, may be problematic since the bond works best with maximum surface areas.

Yet another method for creating multiple color, multiple level surfaces is compression thermoforming. This process requires a mold with female cavities machined into a suitable mold material such as aluminum, magnesium or phenolic sheet material. The mold material must be able to tolerate heat up to 370°F., which is the thermoforming temperature of acrylic sheets typically used in the application. Other thermoplastics such as PET6, ABS, HIPS, PVC and hybrid thermoplastics will also work with various different forming temperatures. In its simplest incarnation, a press, mold part is either clear or colored. If colored, the substrate will require tipping or foil stamping to create contrast. Thus, a paint step is required, Alternatively a pigmented powder mixture with at least some thermoplastic properties, can be deposited selectively into female mold cavities as described, for example, in U.S. Pat. No 7,485,248. The powder melts under the heat and pressure of the process and fuses to the substrate material. No further colorizing is required. This method is limited by the availability of colored thermoplastic powder and the difficulty of custom color grinding to create powder. The essential desirable property created by this approach is that the, color is integral; fused to, the substrate by the powder melting to the forming temperature and engaging under high pressure the heat softened substrate, While the powder and substrate may be selected from different thermoplastics, the two need to have similar softening points.

An alternative colorizing process used in compression forming is to laser or CNC machine cut colored thermoplastic graphics which are placed into the mold. Subsequent heat and pressure thermally fuse the graphics to the substrate. This approach is limited by the availability of thin colored plastic and cannot address the need for custom color applications. Substrates are likewise limited in color range. Painting either on the face surface or reverse is typically used to colorize these products. Alternatively the face or reverse surface, called first and second surfaces in the industry, can be printed on a flatbed digital printer using special inks suitable to heat and pressure. The coloring may be done prior to thermoforming. Direct printing allows for full custom color and pattern creation. However, this process has the limitation of still requiring tipping or foil stamping or placement of cut elements, In addition print ink with or without a clear overcoat may be vulnerable to surface damage. The color limitations of s powder or cut elements likewise applies.

### SUMMARY

It should be appreciated that this Summary is provided to introduce a selection of concepts in a simplified form, the concepts being further described below in the Detailed Description. This Summary is not intended to identify key features or essential features of this disclosure, nor is it intended to limit the scope of the invention.

According to some embodiments of the present invention, a method of making a decorative article, such as a sign or plaque with raised elements/graphics, includes cutting at least one character from a multi-layered, sheet, positioning the at least one character on a mold surface, placing a substrate in contacting relationship with the at least one character, wherein the substrate comprises clear or colored thermoplastic material, and applying a compressive force to the substrate and mold such that the at least one character fuses to the substrate. The multi-layered sheet includes a clear first thermoplastic layer, a second thermoplastic layer, and a printed color layer sandwiched between the first and second thermoplastic layers. The at least one character may be an alpha-numeric character, an image, or a portion of an image, etc.

In some embodiments, applying a compressive force to the substrate and mold includes applying a compressive force of at least about 50 psi to the substrate and mold at a temperature of at least 250° F.

In some embodiments, the at least one character comprises a plurality of characters. As such, the decorative article produced has a plurality of raised portions.

The mold surface may include at least one cavity corresponding to the shape of the at least one character. As such, positioning the at least one character on the mold surface includes positioning the at least one character within the at least one mold cavity. In some embodiments, the at least one character comprises a plurality of characters, and positioning the at least one character on a mold surface comprises positioning the plurality of characters within a respective plurality of mold cavities.

In some embodiments, the substrate has a clear first thermoplastic layer, a second thermoplastic layer, and a printed color layer sandwiched between the first and second thermoplastic layers.

In some embodiments, the printed color layer of the t erne character is flexible and/or thermoplastic print ink.

In some embodiments, the printed color layer of the at least one character includes a plurality of colors and/or designs.

According to other embodiments of the present invention, a method of making a decorative article, such as a sign or plaque with raised elements/graphics, includes cutting at least one character from a multi-layered sheet, wherein the multi-layered sheet comprises a clear thermoplastic layer and a printed color layer of thermoplastic ink. The at least one character is placed on a mold surface such that the printed color layer of thermoplastic ink thereof is exposed, a thermoplastic substrate is placed in contacting relationship with the printed color layer of thermoplastic ink, and a compressive force is applied to the substrate and mold such that the at least one character fuses to the substrate. In this embodiment, the thermoplastic ink and the substrate fuse together without the requirement of another thermoplastic layer over the ink layer.

it is noted that aspects of the invention described with respect to one embodiment may be incorporated in a different embodiment although not specifically described relative thereto. That is, all embodiments and/or features of any embodiment can be combined in any way and/or combination. Applicant reserves the right to change any originally filed claim or file any new claim accordingly, including the right to be able to amend any originally filed claim to depend from and/or incorporate any feature of any other claim although not originally claimed in that manner. These and other objects and/or aspects of the present invention are explained in detail below,

### BRIEF DESCRIPTION OF THE DRAWINGS

The accompanying drawings, which form a part of the specification, illustrate various embodiments of the present invention. The drawings and description together serve to fully explain embodiments of the present invention.

FIG. 1 illustrates an exemplary digital image or CAD file of a decor live article, according to some embodiments of the present invention.

FIG. 2 illustrates a plurality of sheets of thermoplastic material, each having a printed layer of color on a surface thereof.

FIGS. 3 and 4 illustrate characters cut, from the plurality of sheets of FIG. 2, wherein the characters will be used to produce the decorative article represented by the digital file of FIG. 1. FIG. 3 illustrates the plurality of sheets of FIG. 2 with the characters removed therefrom. FIG. 4 illustrates the characters that were removed from the sheets of FIG. 3.

FIG. 5 illustrates a mold for use in producing the decorative article represented by the digital file of FIG. 1, and wherein the mold has respective cavities for the characters of FIG. 4.

FIG. 6 illustrates the characters of FIG. 4 placed in the respective cavities of the mold of FIG. 5.

FIG. 7A is a plan view of a decorative article produced by compression molding a substrate and the characters in the respective cavities of the mold of FIG. 6 such that the characters are fused to the substrate and extend outwardly from the substrate as raised graphics.

FIG. 7B is a perspective view of the decorative article of FIG. 7A illustrating the raised graphics.

FIG. 8 is cross-sectional view of a character fused to a substrate in accordance with embodiments of the present invention and wherein the character has a printed layer and an overlying thermoplastic protective layer on one surface thereof.

FIG. 9 is an enlarged partial view of the portion of FIG. 8 indicated by “A”.

FIG. 10 is cross-sectional view of a character fused to a substrate in accordance with embodiments of the present invention, wherein the character has a printed layer and an overlying thermoplastic protective layer on one surface thereof, and wherein the substrate has a printed layer and an overlying thermoplastic protective layer on one surface thereof.

FIG. 11 is cross-sectional view of a character fused to a substrate in accordance with embodiments of the present invention, wherein the character has a printed layer and an overlying thermoplastic protective layer on one surface thereof, and wherein the substrate has a printed layer and an overlying thermoplastic protective layer on the surface bonded to the character.

### DETAILED DESCRIPTION

The present invention will now be described more fully hereinafter with reference to the accompanying figures, in which embodiments of the invention are shown. This invention may, however, be embodied in many different forms and should not be construed as limited to the embodiments set forth herein. Like numbers refer to like elements throughout. In the figures, certain layers, components or features may be exaggerated for clarity, and broken lines illustrate optional features or operations unless specified otherwise. In addition, the sequence of operations (or steps) is not limited to the order presented in the figures and/or claims unless specifically indicated otherwise. Features described with respect to one figure or embodiment can be associated with another embodiment or figure although not specifically described or shown as such.

It will be understood that hen a feature or element is referred to as being “on” another feature or element, it can be directly on the other feature or element or intervening features and/or elements may also be present. In contrast, when a feature or element is referred to as, being “directly on” another feature or element, there are no intervening features or elements present. It will also be understood that, when a feature or element is referred to as being “secured”, “connected”, “attached” or “coupled” to another feature or element, it can be directly secured, directly connected, attached or coupled to the other feature or element or intervening features or elements may be present. In contrast, when a feature or element is referred to as being, for example, “directly secured”, “directly connected”, “directly attached” or “directly coupled” to another feature or element, there are no intervening features or elements present. Although described or shown with respect to one embodiment, the features and elements so described or shown can apply to other embodiments.

The terminology used herein is for the purpose of describing particular embodiments only and is not intended to be limiting of the invention. As used herein, the singular forms “a”, “an” and “the” are intended to include the forms as well, unless the context clearly indicates otherwise.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

As used herein, the term “and/or” includes any and ail combinations of one or more of the associated listed items and may be abbreviated as “/”.

As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

It will be understood that although the terms first and second are used herein to describe various features or elements, these features or elements should not be limited by these terms. These terms are only used to distinguish one feature or element from another feature or element Thus, a first feature or element discussed below could be termed a second feature or element, and similarly, a second feature or element discussed below could be termed a first feature or element without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The term “about”, as used herein with respect to a value or number, means that the value or number can vary by +/− twenty percent (20%)

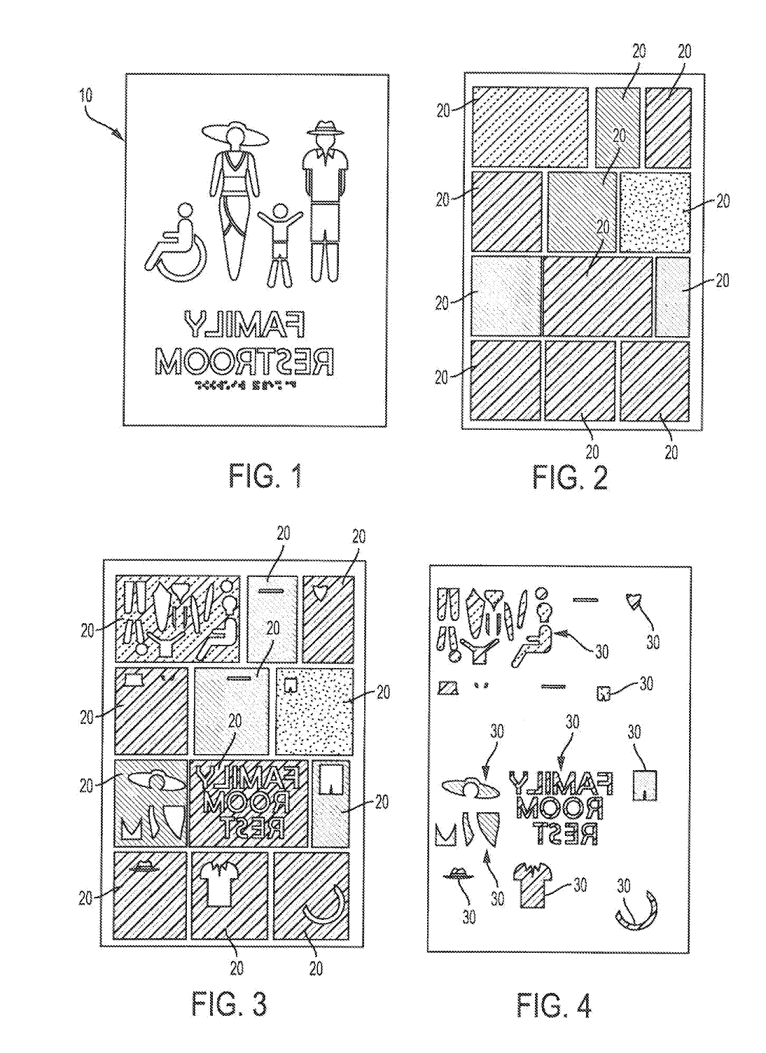

Referring now to FIGS. 1-11, embodiments of the present invention be described. FIG. 1 illustrates an exemplary digital image or CAD file 10 of a decorative article (e.g., a sign or plaque with raised elements/graphics) to be manufactured, according to some embodiments of the present invention. FIG. 2 illustrates a plurality of sheets 20 of thermoplastic material, according to embodiments of the present, invention. In some embodiments, each sheet 20 is a composite comprising a first thermoplastic layer 32 having a layer 34 of ink or other color material printed on a surface thereof of the first layer 32, and a second, protective layer of thermoplastic material 36 overlaid on the printed layer of color and fused to the first thermoplastic layer 32. This is illustrated in greater detail in FIG. 9. As such, the printed layer 34 of color is encapsulated or sandwiched between two layers 32, 36 of thermoplastic material.

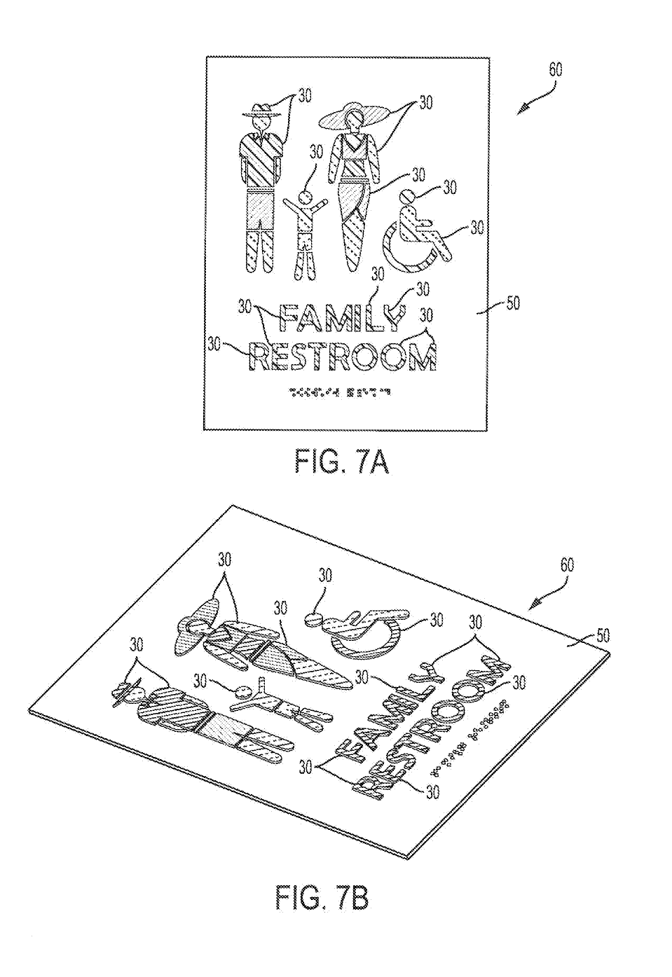

FIGS. 3 and 4 illustrate characters 30 cut from the plurality of sheets 20 of FIG. 2, wherein the characters 30 will be used to produce a decorative article (60, FIGS. 7A-7B) represented by the digital image 10 of FIG. 1. FIG. 3 illustrates the plurality of sheets 20 of FIG. 2 with the characters 30 removed therefrom. The characters 30 may be removed in various ways, such as via a CO₂ laser or other known way of cutting thermoplastic sheets FIG. 4 illustrates the characters 30 after being removed from the sheets 20 of FIG. 3.

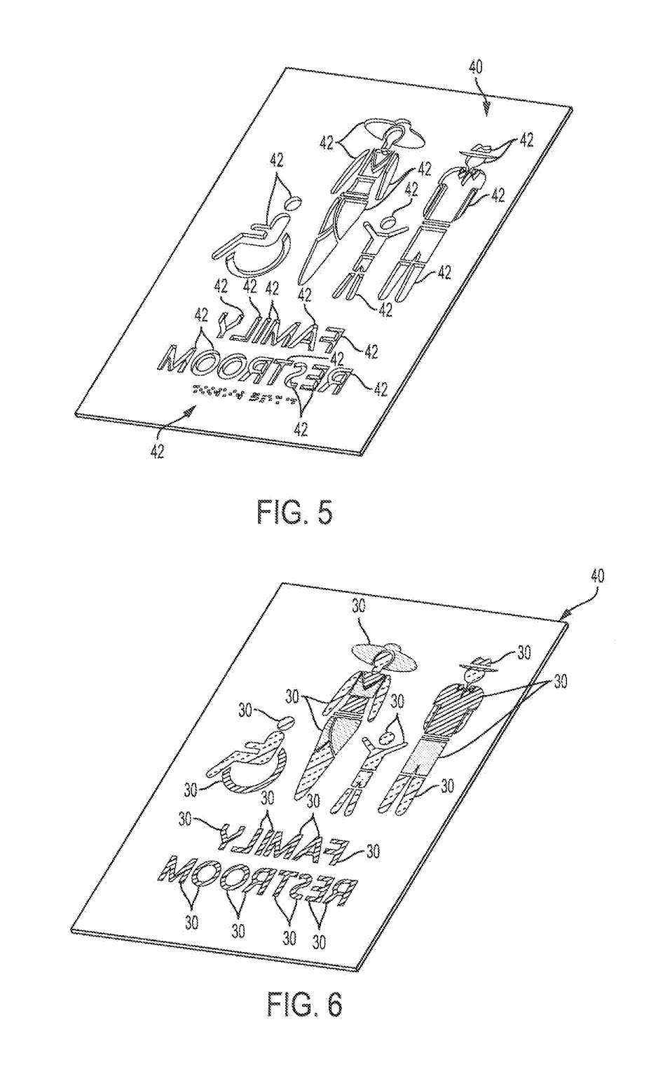

FIG. 5 illustrates a mold 40 for use in producing the decorative article represented by the digital file 10 of FIG. 1, and wherein the mold 40 has respective cavities 42 with corresponding shapes for receiving each of the characters 30 in FIG. 4. FIG. 6 illustrates the characters 30 of FIG. 4 placed in the respective cavities 42 of the mold 40 of FIG. 5. A substrate 50 (FIGS. 7A-7B) is then placed within the mold 40 and fused under temperature and pressure (e.g., via a hot platen press) to the characters 30 such that the characters 30 extend outwardly from the substrate 50 as raised graphics. The resulting decorative article 60 produced thereby is illustrated in FIG. 7A-7B.

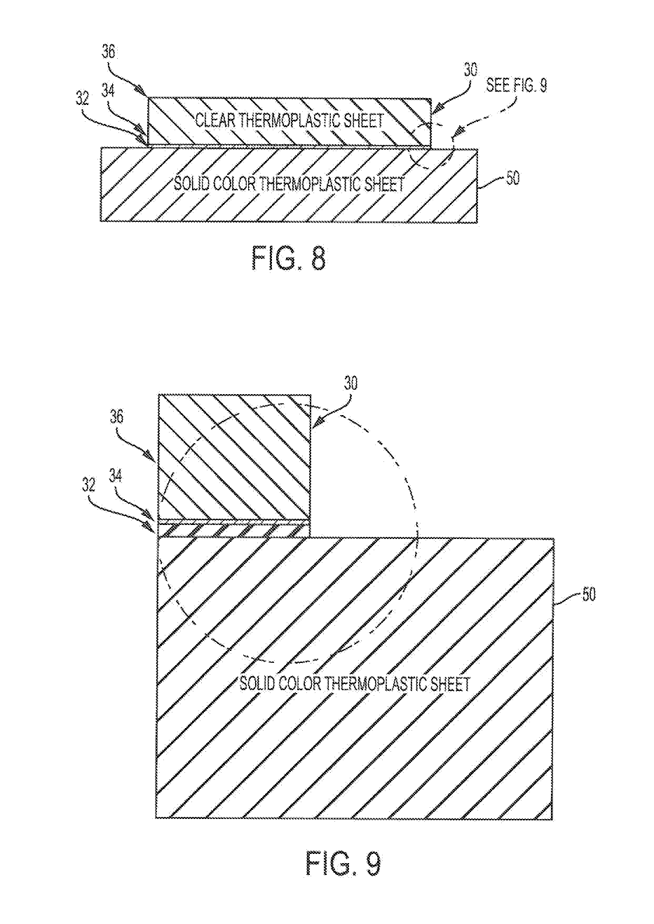

FIG. 8 is cross-sectional view of a character 30 fused to a substrate 50 in accordance with some embodiments of the present invention and wherein the character 30 comprises a thermoplastic layer 32 with a printed layer 34 of ink or other color material thereon, and an overlying thermoplastic protective layer 36 on top of the printed layer 34. The substrate 50 may be a solid color thermoplastic sheet in some embodiments. In other embodiments, the substrate 50 can have multiple colors, as well as patterns, etc. FIG. 9 is an enlarged partial view of the portion of the character 30 and substrate 50 in FIG. 8 indicated by “A”.

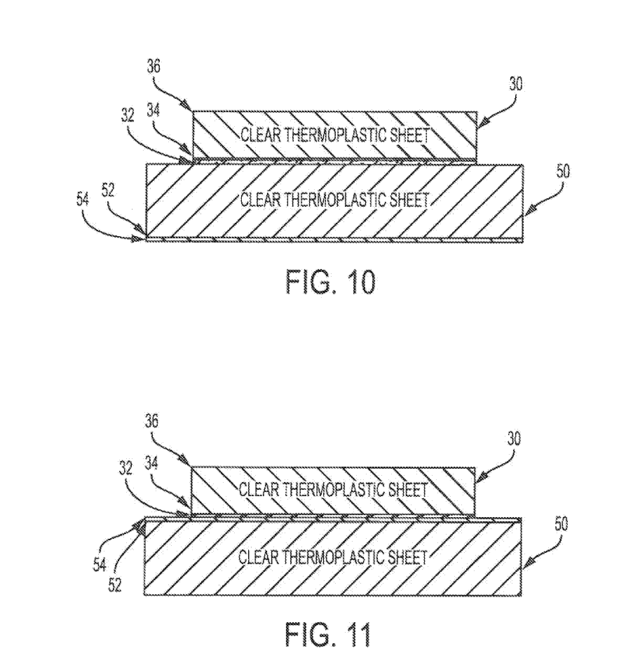

FIG. 10 is cross-sectional view of a character 30 fused to a composite substrate 50 in accordance with some embodiments of the present invention. The character 30 has a thermoplastic layer 32 with a printed layer 34 of ink or other color material on a surface of the thermoplastic layer 32, and an overlying thermoplastic protective layer 36 fused to the thermoplastic layer 32. The substrate 50 has a printed layer 52 of ink or other color material on a surface thereof, and a thermoplastic protective layer 54 overlies the printed layer 52. The thermoplastic protective layer 54 is fused to the substrate.

FIG. 11 is cross-sectional view of a character 30 fused to a composite substrate 50 in accordance with other embodiments of the present invention. The character 30 has a thermoplastic layer 32 with a layer 34 of ink or other color material printed on a surface thereof, and an overlying thermoplastic protective layer 36. The substrate 50 has a printed layer 52 of ink or other color material on a surface thereof, and a thermoplastic protective layer 54 overlies the printed layer 52 and is fused to the substrate 50.

Embodiments of the present invention overcome all of the limitations of the identified conventional processes and greatly expand the range of materials and aesthetics possible. Embodiments of the present invention utilize encapsulated graphics or material which are trapped between or behind clear plastic and thermally fused in a compression process. The encapsulated material may be ink deposited by a direct printer on materials such as cloth or wood veneer. A typical assembly for either the raised portion is clear plastic, visible layer clear plastic. Raised elements are typically created using thin, clear sheet plastic printed on the reverse side with a digital printer. If the ink used is thermoplastic the prepared sheet is ready to be cut into graphics forms. If not a thermoplastic layer may be applied either as a liquid, powder or solid sheet, such as Korad® brand plastic film. The substrate likewise is prepared typically using thicker thermoplastic clear sheets. Both substrate and elements prepared in this way, may be used singularly or in combination with solid colored or powdered created graphics. Different aesthetics, especially in the substrate may be achieved by multiple layers using the same techniques. An advantage of embodiments of the present invention is that the color or material achieved is always protected by a clear plastic layer and is readily customizable. Beauty, toughness and versatility are advantages of decorative articles produced in accordance with embodiments of the present invention.

### Example 1

A sheet of .030″ thick clear acrylic is printed with selective colors and patterns. Printing is done on the back side of the sheet, and a sheet of .003″ thick clear acrylic is placed in registration with the printed acrylic sheet (FIG. 8). The assembly is placed in a hot platen press and subjected to heat at about 360° F. and pressure of about 500 psi. The layers are thermally fused together into a sheet. The assembly is then cooled and removed from press. Individual characters (indicia) are, cut out with a CO₂ laser (or via another method); each character cut from a predetermined part of the print sheet corresponding to the color and or pattern required (FIGS. 3 and 4) for the decorative article. The characters are then placed in the cavities of a mold (FIG. 6). A sheet of solid color (white) acrylic is placed in registration over mold. The assembly is placed in a hot platen press and subjected to heat at about 360° F. and pressure of about 500 psi. The sheet and characters are thermally fused. The assembly is cooled and removed from mold. The colored/patterned, characters are now raised from the surface of the white acrylic substrate and permanently affixed by thermoplastic fusion. A three layer laminae results which is thermally fused together. The sign or plaque is then subjected to post molding processes, cutting, trimming and sanding as required.

### Example 2

Printed sheet is prepared as in Example 1. Characters are laser cut and placed in a mold. A second clear Acrylic sheet .25″ thick is printed on the reverse side with a color which will visually contrast with the color of the characters (FIG. 10). This printed sheet is then placed face down (non-printed side) on the mold, over the positioned characters. A thin acrylic sheet is now placed on the assembly covering the print layer of the substrate. The entire assembly is placed in a hot platen press and subjected to heat at about 360° F. and pressure of about 500 psi. The molded part is cooled and removed from press. A five layer laminae results which is thermally fused. The ink layers are encapsulated and protected. The sign or plague is then subjected to post molding processes, cutting, trimming and sanding as required.

### Example 3

Characters are prepared and positioned in a mold as in Examples 1 and 2. A clear acrylic sheet .25″ thick is printed on the face surface (FIG. 11). A thin clear acrylic sheet is placed over the mold with characters placed as in previous examples. The .25″ clear acrylic sheet with the printed face is placed over the thin acrylic sheet. The entire assembly is placed in a hot platen press and subjected to heat at about 360° F. and pressure of about 500 psi The molded part is cooled and removed from press. A four layer laminae results which is thermally fused together.

All the preceding examples create multi-layer products with raised elements which are created without adhesives or paint. A CAD file is used for mold machining and laser cutting of characters.

The foregoing is illustrative of the present invention and is not to be, construed as limiting thereof. Although a few exemplary embodiments of this invention have been described, those skilled in the art will readily appreciate that many modifications are possible in the exemplary embodiments without materially departing from the teachings and advantages of this invention. Accordingly, all such modifications are intended to be included within the scope of this invention as defined in the claims. The invention is defined by the following claims, with equivalents of the claims to be included therein.

That which is claimed is:

1. A method of making a decorative article with raised graphics, the method comprising:
cutting at least one character from a multi-layered sheet, wherein the multi-layered sheet comprises a clear first thermoplastic layer, a second thermoplastic layer, and a printed color layer sandwiched between the first and second thermoplastic layers;
positioning the at least one character on a mold surface;
placing a substrate in contacting relationship with the at least one character wherein the substrate comprises thermoplastic material;
applying a compressive force to the substrate and mold such that the at least one character fuses to the substrate.

2. The method of claim 1, wherein; the at least one character comprises a plurality of characters.

3. The method of claim 1, wherein positioning the at least one character on the mold surface comprises positioning the at least one character within at least one mold cavity.

4. The method of claim 1, wherein the at least one character comprises a plurality of characters, and wherein positioning the at least one character on the mold surface comprises positioning the plurality of characters within a respective plurality of mold cavities.

5. The method of claim 1, wherein the at least one character is an alpha-numeric character.

6. The method of claim 1, wherein the at least one character is an image or a portion of an image.

7. The method of claim 1, wherein the substrate comprises a clear or colored thermoplastic sheet.

8. The method of claim 1, wherein the substrate comprises a clear first thermoplastic layer, a second thermoplastic layer, and a printed color layer sandwiched between the first and second thermoplastic layers.

9. The method of claim 1, wherein applying a compressive force to the substrate and mold comprises applying a compressive force of at least about 50 psi to the substrate and mold at a temperature of at least 250° F.

10. The method of claim 1, wherein the decorative article is a sign or plaque with raised contrasting decorative elements.

11. The method of claim 1, wherein the printed color layer comprises flexible print ink.

12. method of claim 1, wherein the printed color layer comprises thermoplastic print ink.

13. The method of claim 1, wherein the printed color layer comprises a plurality of colors.

14. A method of making a decorative article with raised graphics, the method comprising:
cutting at least one character from a multi-layered sheet, wherein the multi-layered sheet comprises a clear thermoplastic layer and a printed color layer of thermoplastic ink;
positioning the at least one character on a mold surface such that the printed color layer of thermoplastic ink thereof is exposed;
placing a substrate in contacting relationship with the printed color so layer of thermoplastic ink, wherein the substrate comprises thermoplastic material;
applying a compressive force to the substrate and mold such that the at least one character fuses to the substrate.

15. The method of claim 14, wherein the at least one character comprises a plurality of characters.

16. The method of claim 14, wherein positioning the at least one character on the mold surface comprises positioning the at least one character within at least one mold cavity.

17. The method of claim 14, wherein the at least one character comprises a plurality of characters, and wherein positioning the at least one character on the mold surface comprises positioning the plurality of characters within a respective plurality of mold cavities.

18. The method of claim 14, wherein the at least one character is an alpha-numeric character.

19. The method of claim 14, wherein the at least one character is an image or a portion of an image.
